(19) United States
(12) Patent Application Publication
(10) Pub. No.: US 2010/0120564 A1
(43) Pub. Date: May 13, 2010

(54) HYDRAULIC BELT TENSIONER COMPRISING A SPECIAL PISTON

(75) Inventors: Bernd Hartmann, Weisendorf (DE); Marco Kowalski, Herzogenaurach (DE)

Correspondence Address: LUCAS & MERCANTI, LLP, 475 PARK AVENUE SOUTH, 15TH FLOOR, NEW YORK, NY, 10016, US

(73) Assignee: SCHAEFFLER KG, Herzogenaurach (DE)

(21) Appl. No.: 12/598,664

(22) PCT Filed: Apr. 30, 2008
(86) PCT No.: PCT/EP08/55323

§ 371 Date: Nov. 3, 2009

(30) Foreign Application Priority Data
May 4, 2007 (DE) 10 2007 020 885.7

(51) Int. Cl. F16H 7/08

(52) U.S. Cl. 474/110

(57) ABSTRACT

A hydraulic belt tensioner for a unit drive or control drive of a motor vehicle. The belt tensioner has a cylinder housing in which a damper piston with a piston rod is arranged to be axially retracted against the force of a compression spring. A damping valve is integrated into the damper piston which, when interacting with a pressure compartment in the cylinder housing, are a component of a hydraulic damping system that is effective in the direction of retraction of the piston rod. The damping piston is produced from a shaped metal sheet piece that is guided inside the cylinder housing with very little play. The interior of the damping piston forms a receptacle for the damping valve configured as a throttle-check valve.

### FIELD OF THE INVENTION

The present invention relates to a hydraulic belt tensioner for a unit drive or control drive of a motor vehicle, with a cylinder housing in which a damping piston with a piston rod is arranged in a manner such that it can be retracted axially counter to the force of a compression spring, wherein damping valve means are integrated in the damping piston, said damping valve means, in interaction with a pressure space formed in the cylinder housing, being part of a hydraulic damping means acting in the retraction direction of the piston rod.

The field of use of hydraulic belt tensioners primarily involves the belt drive for driving auxiliary units, such as a coolant pump, electric generator and air-conditioning compressor of a motor vehicle, which auxiliary units are customarily fastened to the engine. The crankshaft of the motor vehicle engine supplies the driving power, and the belt drive transmits the driving power to driving pulleys of the respective auxiliary units. With a hydraulic belt tensioner also included in the belt drive, a uniformly high tensioning of the belt is ensured, and therefore as little slip as possible is arising between the belt and the driving or driven pulleys.

U.S. Pat. No. 4,790,801 reveals a hydraulic belt tensioner of the type in question. The belt tensioner here comprises a cylinder housing into which a damping piston formed in the manner of a plunger piston protrudes in a manner such that it can be retracted and extended. Said piston-cylinder arrangement is surrounded by a compression spring which brings the two parts into the extended initial position. While a pressure space of a hydraulic damping means is formed between the damping piston and the cylinder housing, the piston-cylinder arrangement is surrounded by a further, outer, cup-like housing part, the annular interior of which forms the unpressurized storage space of the hydraulic damping means. The damping piston is retracted here in a damped manner by the damping oil present in the pressure space passing into the storage space via throttling means integrated on the bottom side of the cylinder housing. This takes place in a correspondingly damped manner in accordance with the effective throttling cross section. By contrast, a non-return valve is in effect for the extension of the damping piston such that said movement takes place in a substantially undamped manner. The damping valve means arranged on the bottom side of the cylinder housing substantially comprise a valve ball, which is arranged under the loading of a compression spring within a cage and presses against a valve seat in order to realize the non-return valve. A disadvantage of this solution appears to be the relatively high assembly costs, since in particular the damping valve means have to be fitted on the bottom side of the cylinder housing, which presupposes a correspondingly divided cylinder housing.

U.S. Pat. No. 6,036,612 discloses a hydraulic belt tensioner of the type in question, in which, in contrast to the above-explained prior art, the damping valve means are integrated on the damping piston. The damping piston compresses a solid cast part and has a central restricting bore which connects a bottom side pressure space formed in the cylinder housing with a storage space on the piston rod of the hydraulic damping means. A non-return valve in the form of a valve ball pressing against a valve seat is also formed here. Although the damping valve means, which are integrated in the damping piston, can be pre-assembled in the damping piston before the latter is joined to the cylinder housing, in this solution manufacturing inaccuracies in the damping piston which is of solid design have a negative effect on the damping action. Furthermore, in a technical solution of this type, a damping force, which is proportional to the piston speed, is produced. Said damping force may become extremely large under unfavorable operating conditions, such as low temperatures, which leads to considerable unit loads.

Furthermore, DE 10 2004 047 450 A1 shows a hydraulic tensioning element with a cylinder and a piston, wherein a valve sub-assembly, via which the volume exchange of the hydraulic fluid takes place, is assigned to the end side of the piston.

It is the object of the present invention to provide a hydraulic belt tensioner which is designed in a simple manner and can be reproduced with consistent quality and which realizes approximately consistent damping forces under unfavorable operating conditions.

The object is achieved on the basis of a hydraulic belt tensioner according to the preamble of claim 1 in conjunction with the characterizing features of said claim. The subsequent dependent claims reflect advantageous developments of the invention.

The invention includes the technical teaching that the damping valve means, which are accommodated in the interior of the damping piston, are fixed by means of a radially inwardly crimped, bottom side edge of the damping piston.

The advantage of the solution according to the invention resides in particular in the fact that modern manufacturing techniques enable a damping piston to be produced as a punched and bent part which already has exacting component tolerances as a result of the manufacturing process. The damping piston is guided through the cylinder housing, i.e. there is no throttling gap between the damping piston and cylinder housing. Instead, the restriction and the non-return valve function of the damping valve means are formed by components arranged in the interior of the damping piston. Said components can for the most part be produced as punched and bent parts from sheet metal and likewise with relatively little outlay on the manufacturing process.

For example, the damping valve means may include an annular body which is arranged on the bottom side of the damping piston and in which throttling or laminar gap openings are placed in order to fulfill the damping function.

In order to limit the damping force, it is proposed according to another measure improving the invention, to use a compression spring which presses the radially inwardly crimped, bottom side edge of the damping piston in the form of a valve plate against the body forming a valve seat. For as long as the pressure in the pressure space is lower than the prestressing force of said compression spring, the valve is closed, and above a limit pressure defined by the prestressing force of the compression spring the valve opens for the purpose of limiting the damping force. In order to integrate the compression spring in the interior of the damping piston in a likewise space-saving manner, it is proposed to form said compression spring in the manner of a corrugated spring or disk spring. In this case, the damping oil can flow to and fro between the pressure space and a storage space formed in the piston rod through the corrugated or disk spring, i.e. through the circular opening therein.

The non-return valve, which still belongs to the damping valve means, preferably comprises a valve plate which is acted upon by a compression spring and presses against a valve seat disk such that, during an extension movement of the piston rod, damping oil can pass from the storage space into the pressure space in a manner which is as unthrottled as possible. The components of the non-return valve can also be manufactured as punched and bent parts from sheet metal.

According to another measure improving the invention, it is provided that the prestressing of the compression spring for limiting the damping force can be set in a simple manner via the dimensioning of the interior height of the damping piston.

It is furthermore proposed to ensure that the piston rod is guided relative to the cylinder housing via a guide ring which is inserted on the opening-side of the cylinder housing and also serves at the same time, with the effect of an integration of functions, to form an upper end stop for the damping piston. The movable part of the hydraulic belt tensioner is therefore supported in a stable manner and guided in a statically defined manner along its working movement at two points, namely by the guide ring and by two points, namely by the guide ring and by the damping piston.

For the purpose of sealing the damping-oil-filled interior of the cylinder housing in relation to the surroundings, the guide ring itself may also include radial sealing means in the interior. However, as an alternative thereto, it is also possible to provide a separate sealing ring for the dynamic sealing of the piston rod on that side of the guide ring which lies opposite the damping piston.

According to another measure improving the invention, the damping piston can be designed as a component which is separate from the piston rod. In this case, it is proposed to press the damping piston into the tubular piston rod via a tube section, a radially outwardly crimped edge of the piston rod coming into contact with the guide ring on the cylinder housing. The crimped edge of the piston rod therefore strikes against the guide ring which is on the cylinder housing and is therefore positionally fixed, and therefore the upper end stop is realized without having an adverse effect on the pressing connection to the damping piston.

Other measures improving the invention are explained in more detail below together with the description of a preferred exemplary embodiment with reference to the figures, in which:

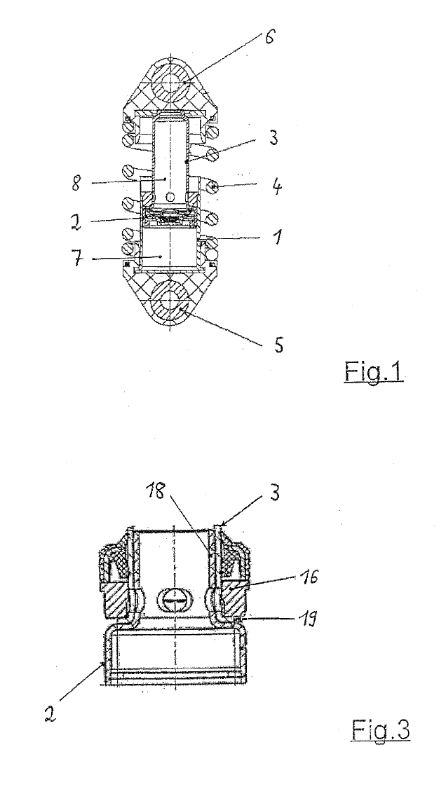

FIG. 1 shows a side view in a sectional illustration of a hydraulic belt tensioner;

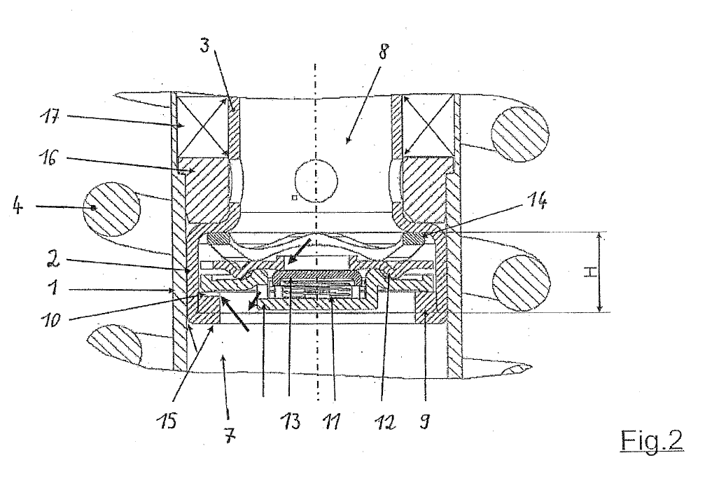

FIG. 2 shows an enlargement of a detail of the belt tensioner according to FIG. 1 in the region of the damping piston; and

FIG. 3 shows an alternative embodiment of a damping piston in interaction with a piston rod.

According to FIG. 1, the hydraulic belt tensioner has a cylinder housing 1 into which a damping piston 2 with a piston rod 3 emerging therefrom protrudes from one end side. A compression spring 4 which acts between the cylinder housing 1 and the damping piston 2 together with the piston rod 3 brings the damping piston 2 into an extended basic position.

In order to install the hydraulic belt tensioner, the latter has a first fastening flange 5, which is formed in a positionally fixed manner with respect to the cylinder housing 1, and a second fastening flange 6, which is formed in a positionally fixed manner with respect to the piston rod 3.

In the hydraulic belt tensioner, the damping valve means are integrated in the damping piston 2 which, in interaction with the cylinder housing 1, forms a pressure space 7. By contrast, a storage space 8 for damping oil is located on the opposite side of the damping piston 2, in a manner such that it is integrated in the piston rod 3.

According to FIG. 2, the damping piston 2 is produced from a sheet-metal formed part and is guided in the cylinder housing 1 with a narrow guiding clearance. Damping valve means, which function in the manner of a one-way restrictor, are arranged in the interior of the damping piston 2.

An annular body 9, which is arranged on the bottom side of the damping piston 2, is provided for throttling. Laminar gap openings 10 are placed into the annular body 9 and, during the retraction movement of the piston rod 3, bring about a throttling in which damping oil passes from the pressure space 7 into the storage space 8 in a throttled manner.

The damping valve means furthermore comprise a non-return valve which has a valve plate 13 which is acted upon by a compression spring 11 and presses against a valve seat disk 12. During an extension movement of the piston rod 3, the damping oil can therefore pass from the storage space 8 into the pressure space 7 in a largely unthrottled manner.

Furthermore, the damping valve means also comprise a means of limiting the damping force which has a compression spring 14, which is formed in the manner of a corrugated spring and presses an inwardly crimped, bottom edge 15 of the damping piston 2 as a valve plate against the annular body 9, which forms a valve seat. For as long as the pressure in the pressure space 7 is lower than the prestressing force exerted by the compression spring 14, said means of limiting the damping force remains closed. The means of limiting the damping force opens only when the pressure in the pressure space 7 becomes correspondingly higher.

The above-described damping valve means accommodated in the interior of the damping piston 2 are fixed there by means of the inwardly crimped, bottom edge 15 of the damping piston 2.

A guide ring 16, which serves for guiding the piston rod 3 and also for forming an upper end stop for the damping piston 2, is furthermore pressed into the cylinder housing 1. A sealing ring 17 is pressed in on that side of the guide ring 16 which lies opposite the damping piston 2. The sealing ring 17 serves for the dynamic sealing of the piston rod 3 during the retraction and extension movement.

FIG. 3 shows a two-part construction of the constructional unit comprising the damping piston 2 and piston rod 3. The damping piston 2 is pressed here into the tubular piston rod 3 via a tube section 18. In this case, an edge 19 crimped in an outwardly radial manner on the piston rod 3 interacts with the guide ring 16 on the cylinder housing for the purpose of forming an end stop.

### REFERENCE NUMBERS

1 Cylinder housing
2 Damping piston
3 Piston rod
4 Compression spring
5 First fastening flange
6 Second fastening flange
7 Pressure space
8 Storage space
9 Annular body
10 Laminar gap opening
11 Compression spring
12 Valve seat disk
13 Valve plate
14 Compression spring
15 Edge
16 Guide ring
17 Sealing ring
18 Tube section
19 Edge

1. A hydraulic belt tensioner for a unit drive or control drive of a motor vehicle, comprising:
a cylinder housing in which a damping piston with a piston rod is arranged in a manner such that the damping piston can be retracted axially counter to a force of a compression spring,
wherein damping valve means are integrated in the damping piston, the damping valve means, in interaction with a pressure space formed in the cylinder housing, being part of a hydraulic damping means acting in a retraction direction of the piston rod,
wherein the damping piston is produced from a sheet-metal formed part which is guided in the cylinder housing with a narrow guiding clearance,
wherein an interior of the damping piston forms a receptacle for damping valve means which is a one-way restrictor, and
wherein the damping valve means, which are accommodated in the interior of the damping piston, are fixed by means of a radially inwardly crimped, bottom edge of the damping piston.

2. The hydraulic belt tensioner of claim 1, wherein the damping valve means have throttling or laminar gap openings placed in an annular body, arranged on the bottom edge of the damping piston.

3. The hydraulic belt tensioner of claim 1, wherein the damping valve means for limiting damping force has a compression spring which presses the bottom edge of the damping piston against an annular body, which forms a valve seat, for as long as pressure in the pressure space is lower than a prestressing force of the compression spring.

4. The hydraulic belt tensioner of claim 3, wherein the compression spring is a corrugated spring or a disk spring through which damping oil flows between the pressure space and a storage space formed in the piston rod.

5. The hydraulic belt tensioner of claim 3, wherein prestressing of the compression spring can be set via dimensioning of an interior height of the damping piston.

6. The hydraulic belt tensioner of claim 1, wherein the damping valve means is a non-return valve having a valve plate which is acted upon by a compression spring and presses against a valve seat disk such that, during an extension movement of the piston rod, damping oil passes from a storage space into the pressure space.

7. The hydraulic belt tensioner of claim 1, wherein a guide ring for guiding the piston rod and for forming an upper end stop for the damping piston is arranged in a positionally fixed manner in the cylinder housing.

8. The hydraulic belt tensioner of claim 7, wherein a sealing ring for dynamic sealing of the piston rod is arranged on that a side of the guide ring which lies opposite the damping piston.

9. The hydraulic belt tensioner of claim 7, wherein the damping piston is designed as a component which is separate from the piston rod and is pressed into the piston rod via a tube section, a radially outwardly crimped border of the piston rod coming into contact with the guide ring on the cylinder housing in order to form an end stop.
